(19) United States
(12) Patent Application Publication
(10) Pub. No.: US 2009/0299238 A1
(43) Pub. Date: Dec. 3, 2009

(54) SINGLE-MOTOR BODY MASSAGER

(76) Inventor: Chien-Ming HUANG, Taipei (TW)

Correspondence Address: PATENTTM.US, P. O. BOX 82788, PORTLAND, OR, 97282-0788, US

(21) Appl. No.: 12/131,441

(22) Filed: Jun. 2, 2008

(51) Int. Cl. A61H 7/00

(52) U.S. Cl. 601/101; 601/99; 601/100

(57) ABSTRACT

A single-motor body massager has a base, a carriage, a motor, a transmission assembly, two massaging assemblies, a moving gear assembly and an outer cover. The carriage is mounted movably on the base. The motor is mounted on the carriage. The transmission assembly is mounted on the carriage and is driven by the motor. The massaging assemblies and the moving gear assembly are mounted on the carriage and are driven by the motor. The outer cover is mounted on the base to protect the components. The single-motor body massager uses only one motor to provide a moving and swiveling massaging function. Thus, the single-motor body massager has simplified structure and reduces the manufacture cost.

### BACKGROUND OF THE INVENTION

1. Field of the Invention

The present invention relates to a body massager, particularly to a single-motor body massager having a simplified structure.

2. Description of the Prior Arts

Body massagers are widely used to massage the users to make the users feel relax and comfortable. A conventional body massager has a massage assembly moving back and forth to massage a wide area of the body of the user. However, the conventional body massager needs to have many and complicated components to move the massage assembly. Due to the complexities of the conventional body massager, the manufacturing process of the conventional body massager is complicated and the prime cost of the body massager is high.

Furthermore, to provide a larger-ranged massage function, the conventional body massager requires two motors. One of the motors moves the massage assembly back and forth, and the other one of the motors provides the massage function. Therefore, the conventional body massager needs a complicated guide system to stable the movement of the massage assembly. Thus, the complicated guide system also needs complicated manufacturing process and costs high.

To overcome the shortcomings, the present invention provides a single-motor body massager to mitigate or obviate the aforementioned problems.

### SUMMARY OF THE INVENTION

The main objective of the present invention is to provide a single-motor body massager. The single-motor body massager has a base, a carriage, a motor, a transmission assembly, two massaging assemblies, a moving gear assembly and an outer cover. The carriage is mounted movably on the base. The motor is mounted on the carriage. The transmission assembly is mounted on the carriage and is driven by the motor. The massaging assemblies and the moving gear assembly are mounted on the carriage and are driven by the motor. The outer cover is mounted on the base to protect the components. The single-motor body massager uses only one motor to provide a moving and swiveling massaging function. Thus, the single-motor body massager has simplified structure and reduces the manufacture cost.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the single-motor body massager in accordance with the present invention;

FIG. 2 is an exploded perspective view of the body massager in FIG. 1;

FIG. 3 is a top view of the carriage of the body massager in FIG. 1;

FIG. 4 is a side view of the motor and the worm wheel of the body massager in FIG. 1;

FIG. 5 is an enlarged exploded perspective view of the body massager in FIG. 1;

FIG. 6 is a perspective view of the body massager in FIG. 1 without the outer cover;

FIG. 7 is a top view of the body massager in FIG. 1 without the outer cover; and

FIG. 8 is an operational top view of the body massager in FIG. 1 without the outer cover.

### DETAILED DESCRIPTION OF THE PREFERRED EMBODIMENTS

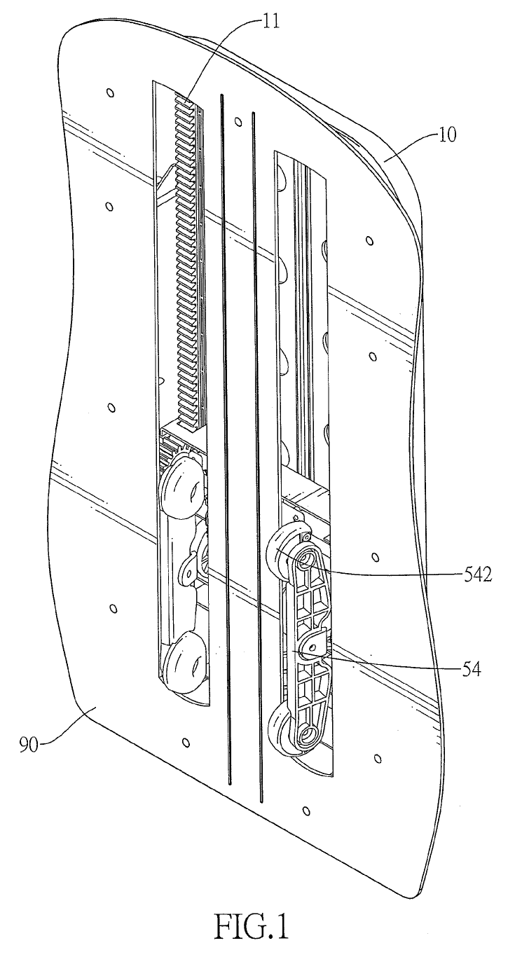

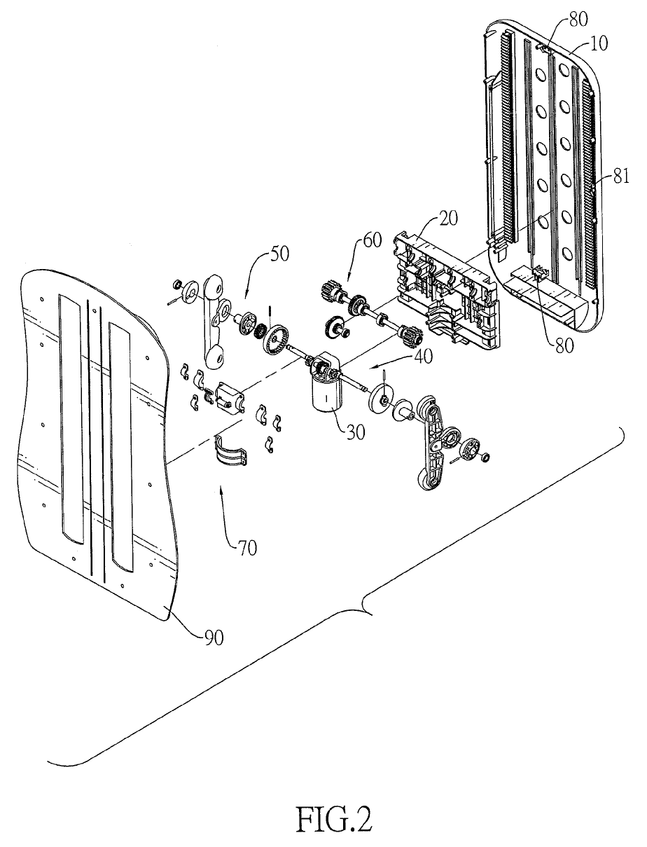

With reference to FIGS. 1 and 2, a single-motor body massager in accordance with the present invention comprises a base (10), a carriage (20), a motor (30), a transmission assembly (40), two massaging assemblies (50), a moving gear assembly (60), a bearing assembly (70), two reverse switches (80), a middle switch (81) and an outer cover (90).

The base (10) has a top surface and two gear racks (11). The gear racks (11) are formed oppositely on the top surface of the base (10) and are parallel to each other.

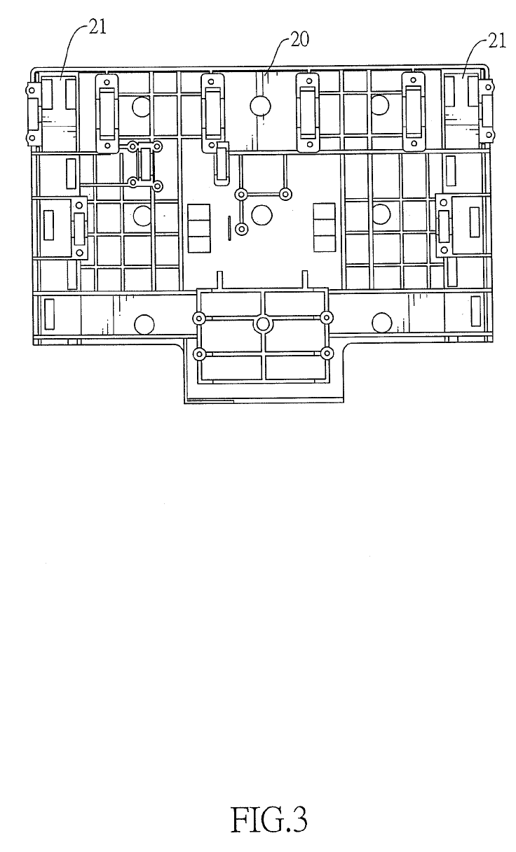

With reference to FIGS. 2 and 3, the carriage (20) is mounted movably on the top surface of the base (10) and has two ends, a top surface and two through holes (21). The through holes (21) are formed oppositely through the carriage (20) and respectively correspond to the gear racks (11) on the base (10).

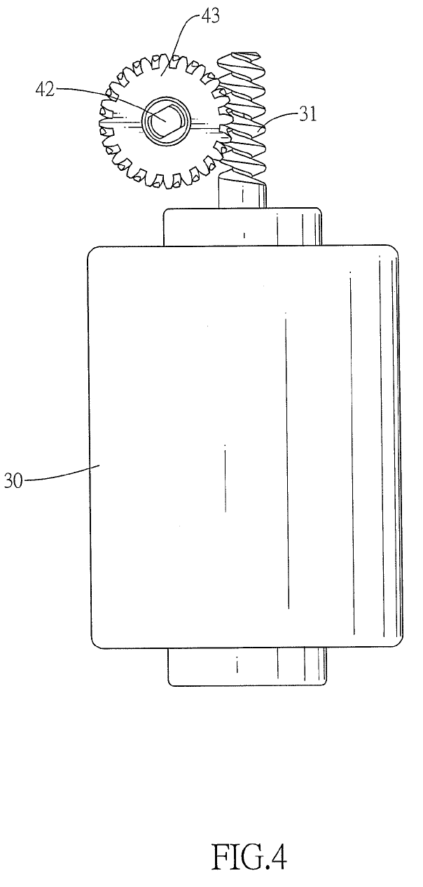

With reference to FIGS. 2 and 4, the motor (30) is mounted securely on the top surface of the carriage (20) and has a top and a worm (31). The worm (31) protrudes out from the top of the motor (30).

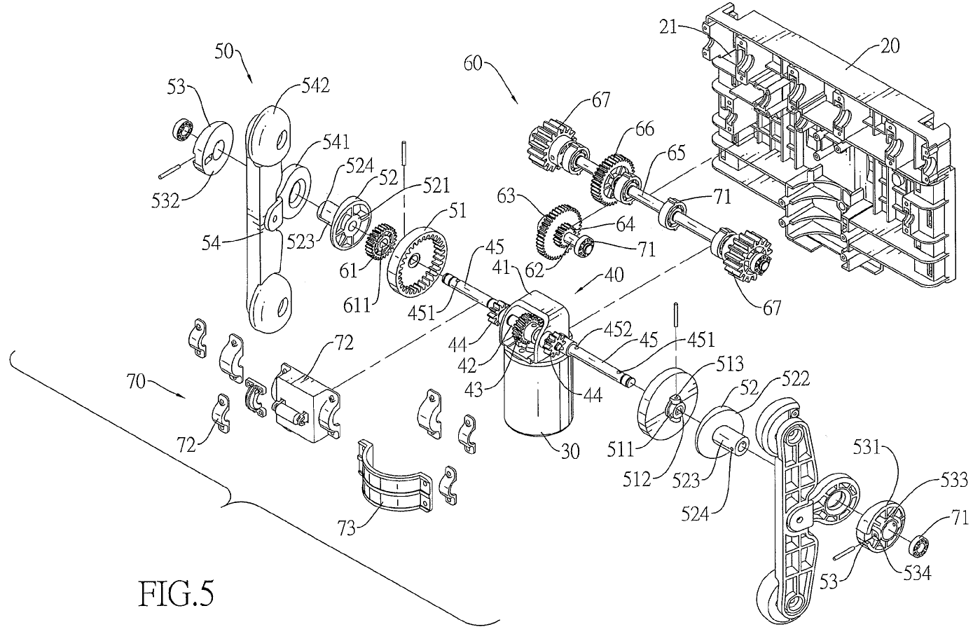

With reference to FIGS. 4 and 5, the transmission assembly (40) is connected to and is driven by the motor (30) and comprises a holding bracket (41), a central rod (42), a worm wheel (43), two planet gears (44) and two driving rods (45).

The holding bracket (41) is mounted securely on the top of the motor (30), is mounted around the worm (31) and has an inner cavity and two sides.

The central rod (42) is keyed, is mounted in the inner cavity of the holding bracket (41) and has two ends. The ends of the central rod (42) are mounted respectively through the sides of the holding bracket (41).

The worm wheel (43) is mounted securely around and drives the central rod (42), is mounted in the inner cavity of the holding bracket (41) and meshes with and is driven by the worm (31) on the motor (30).

The planet gears (44) are respectively mounted securely around the ends of the central rod (42) and are driven by the central rod (42).

The driving rods (45) are keyed and are respectively mounted rotatably in the sides of the holding bracket (41). Each driving rod (45) has a proximal end, a distal end, a first rod pinhole (451) and a second rod pinhole (452). The first rod pinhole (451) is formed through the driving rod (45) near the distal end of the driving rod (45). The second rod pinhole (452) is formed through the driving rod (45) near the proximal end of the driving rod (45).

The massaging assemblies (50) are mounted respectively on two sides of the transmission assembly (40) and are driven by the transmission assembly (40). Each massaging assembly (50) corresponds to one driving rod (45) and comprises an internal gear (51), a first cam (52), a second cam (53) and a massaging bar (54).

The internal gear (51) meshes with and is driven by the corresponding planet gear (44), is mounted securely around the corresponding driving rod (45) and has an outside surface, a central shaft (511), a keyhole (512) and a pinhole (513). The central shaft (511) is formed on and protrudes out from the outside surface of the internal gear (51). The keyhole (512) is formed longitudinally through the central shaft (511) and engages the corresponding driving rod (45) to mount the internal gear (51) securely around the corresponding driving rod (45). The pinhole (513) is formed transversely through the central shaft (511) and aligns with the second rod pinhole (452) of the corresponding driving rod (45). A pin is mounted securely through the pinhole (513) of the central shaft (511) and the second rod pinhole (452) of the corresponding driving rod (45) to mount the internal gear (51) securely around the corresponding driving rod (45).

The first cam (52) is rotated by the transmission assembly (40), is mounted securely around the corresponding driving rod (45) and has an abutting surface (521), an inclined surface (522), a mounting tube (523) and a cam pinhole (524). The inclined surface (522) is opposite to the abutting surface (521) and has a lower part and a higher part. The mounting tube (523) is formed on and protrudes longitudinally out from the inclined surface (522) and is mounted securely around the corresponding driving rod (45). The cam pinhole (524) is formed through the mounting tube (523) and aligns with the first rod pinhole (451).

The second cam (53) is connected securely to the first cam (52), is mounted securely around the mounting tube (523) and has an abutting surface (531), an inclined surface (532), a mounting tube (533) and a cam pinhole (534). The inclined surface (532) is opposite to the abutting surface (531) of the second cam (53), corresponds to the inclined surface (522) of the first cam (52) and has a lower part and a higher part. The lower part of the inclined surface (532) of the second cam (53) corresponds to the higher part of the inclined surface (522) of the first cam (52). The higher part of the inclined surface (532) of the second cam (53) corresponds to the lower part of the inclined surface (522) of the first cam (53). Thus, a leaning passage is formed between the inclined surfaces (522, 532) of the first and second cams (52, 53). The mounting tube (533) is formed on and protrudes longitudinally out from the inclined surface (532) and is mounted securely around the mounting tube (523) of the first cam (52). The cam pinhole (534) is formed through the mounting tube (533) and aligns with the cam pinhole (524) of the first cam (52). A pin is mounted securely through the cam pinholes (524, 534) and the first rod pinhole (451) to mount the first and second cam (52, 53) securely around the corresponding driving rod (45).

The massaging bar (54) is mounted between and is swiveled by the first and second cams (52, 53) and has a side, two ends, a mounting ring (541) and two massaging nodes (542). The mounting ring (541) is formed on and protrudes out from the side of the massaging bar (54), is mounted around the mounting tube (523) of the first cam (52) and is mounted in the leaning passage between the first and second cam (52, 53). The massaging nodes (542) are formed respectively on the ends of the massaging bar (54).

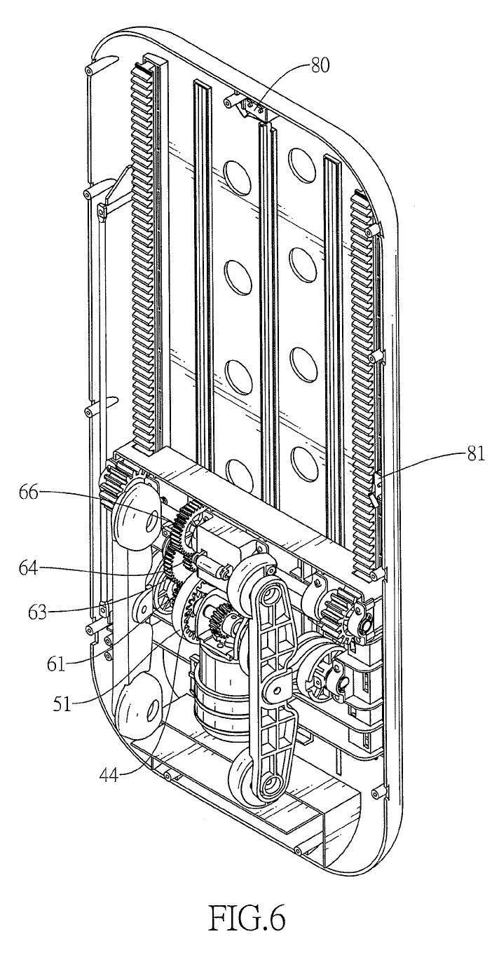

With reference to FIGS. 5 and 6, the moving gear assembly (60) is mounted securely on the top surface of the carriage (20) and is connected to and is driven by the transmission assembly (40). The moving gear assembly (60) comprises a drive gear (61), a transfer shaft (62), a first driven gear (63), a transfer gear (64), a driven shaft (65), a second driven gear (66) and two moving gears (67).

The drive gear (61) is mounted securely around one driving rod (45) and has a keyhole (611). The keyhole (611) is formed longitudinally through the drive gear (61) and engages the corresponding driving rod (45) to mount the drive gear (61) securely around the corresponding driving rod (45).

The transfer shaft (62) is mounted rotatably on the top surface of the carriage (20) and is parallel to the driving rods (45).

The first driven gear (63) is mounted securely around and rotates the transfer shaft (62) and meshes with and is driven by the drive gear (61).

The transfer gear (64) is mounted securely around and is rotated by the transfer shaft (62).

The driven shaft (65) is mounted rotatably on the top surface of the carriage (20), is rotated by the transmission assembly (40), is parallel to the transfer shaft (62) and has two ends.

The second driven gear (66) is mounted securely around and rotates the driven shaft (65) and meshes with and is driven by the transfer gear (64).

The moving gears (67) are respectively mounted securely on the ends of the driven shaft (65), is rotated by the driven shaft (67), respectively protrudes out of the through holes (21) of the carriage (20) and respectively meshes with the gear racks (11) on the base (10).

With reference to FIGS. 5 and 6, the bearing assembly (70) comprises multiple bearings (71), multiple bearing covers (72) and a motor cover (73). The bearings (71) are mounted respectively around the driving rods (45), the transfer shaft (62) and the driven shaft (65) and are mounted on the top surface of the carriage (20) to reduce the abrasion of the driving rods (45), the transfer shaft (62) and the driven shaft (65). The bearing covers (72) are mounted respectively on the bearings (71) to protect the bearings (71). The motor cover (73) is mounted on the motor (30) to protect the motor (30).

With reference to FIG. 6, the reverse switches (80) are mounted on the top surface of the carriage (20), are respectively near the ends of the carriage (20) and is selectively pressed by carriage (20) to reverse the motor (30).

The middle switch (81) is mounted on the top surface of the base (10) and is mounted between the reverse switches (80). Furthermore, the user may let the carriage (20) move between the middle switch (121) and one of the reverse switch (12) to provide massaging function especially direct to the upper back or the lower back of the human body.

With reference to FIGS. 1 and 2, the outer cover (90) is mounted on the top surface of the carriage (20) to protect other elements on the carriage (20) and has two slots (91). The slots (91) are formed through the outer cover (90), align with the gear racks (11) and are mounted respectively around the massaging bars (54) to allow the massaging nodes (542) to protrude through the slots (91) to provide massaging function.

With reference to FIGS. 4 and 5, when the motor (30) operates, the worm (31) is rotated and drives the worm wheel (43). The planet gears (44) are driven by the worm wheel (43) through the central rod (42) and drive the internal gears (51) to rotate. Then the driving rods (45) are rotated.

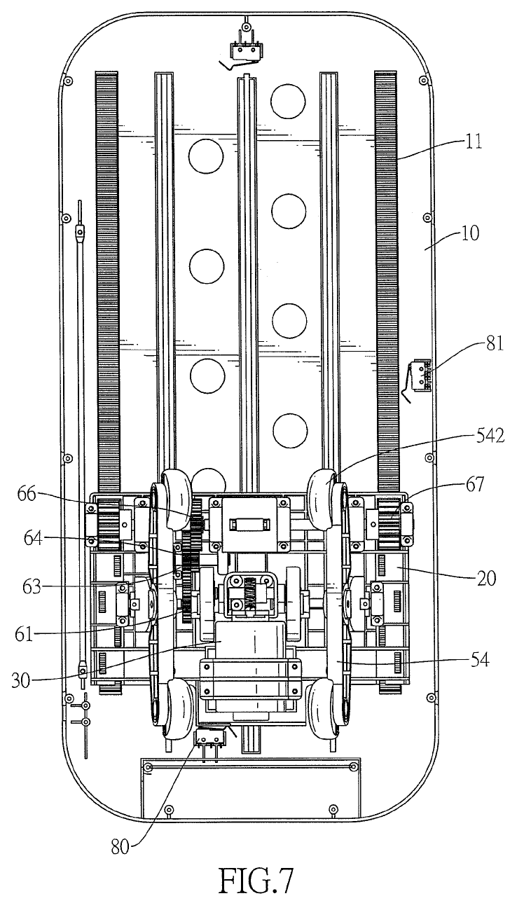

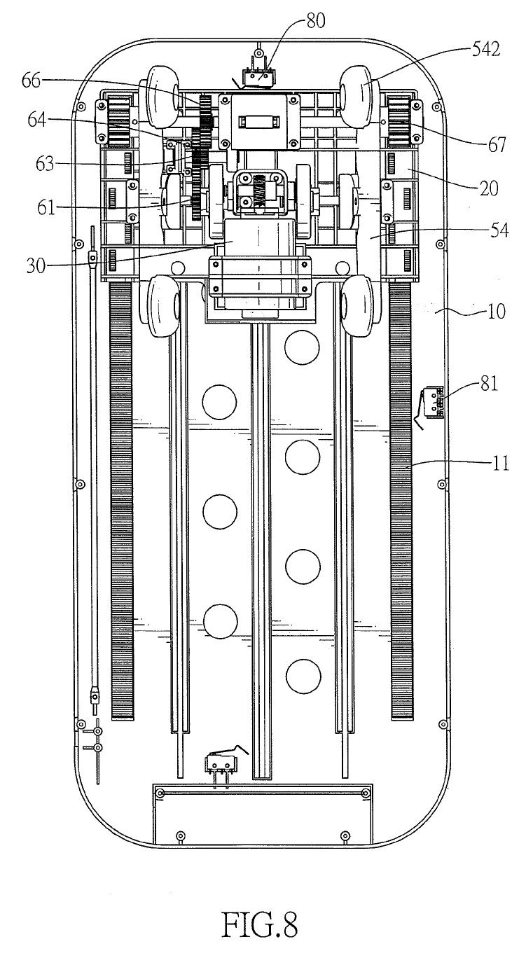

With further reference to FIGS. 7 and 8, when the driving rods (45) are rotated, the first and second cams (52, 53) are rotated. Because the leaning passages between the cams (52, 53) are rotated with the cams (52, 53), the mounting rings (541) are swiveled. Therefore, the massaging bars (54) are swiveled to provide massaging function.

When the driving rods (45) are rotated, the drive gear (61) is rotated. Then the second driven gear (66) is rotated through the first driven gear (63) and the transfer gear (64). The moving gears (67) are rotated with the driven shaft (65) and move along the gear racks (11). Therefore, the carriage (20) is moved on the base (10) to allow the massaging nodes (542) to provide large areas massaging function.

The single-motor body massager as described uses only one motor (30) to provide a moving and swiveling massaging function. Thus, the body massager as described has simplified structure and reduces the manufacture cost.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A single-motor body massager comprising:
a base having a top surface;
a carriage being mounted movably on the top surface of the base and having two ends and a top surface;
a motor mounted securely on the top surface of the carriage;
a transmission assembly being connected to and is driven by the motor;
two massaging assemblies being mounted respectively on two sides of the transmission assembly and being driven by the transmission assembly, and each massaging assembly comprising
a first cam being rotated by the transmission assembly and having
an abutting surface; and
an inclined surface being opposite to the abutting surface and having a lower part and a higher part;
a second cam being rotated by the transmission assembly and having
an abutting surface; and
an inclined surface being opposite to the abutting surface of the second cam, corresponding to the inclined surface of the first cam and having
a lower part of the inclined surface of the second cam corresponding to the higher part of the inclined surface of the first cam; and
a higher part of the inclined surface of the second cam corresponding to the lower part of the inclined surface of the first cam;
a leaning passage being formed between the inclined surfaces of the first and second cams; and
a massaging bar being mounted between and being swiveled by the first and second cams and having
a side; and
a mounting ring being formed on and protruding out from the side of the massaging bar and being mounted in the leaning passage between the first and second cam;
a moving gear assembly being mounted securely on the top surface of the carriage and being connected to and being driven by the transmission assembly; and
an outer cover being mounted on the top surface of the carriage.

2. The body massager as claimed in claim 1, wherein the base has two gear racks being formed oppositely on the top surface of the base and being parallel to each other; and
the moving gear assembly has
a driven shaft being mounted rotatably on the top surface of the carriage, being rotated by the transmission assembly and having two ends; and
two moving gears being respectively mounted securely on the ends of the driven shaft, being rotated by the driven shaft and respectively meshing with the gear racks on the base.

3. The body massager as claimed in claim 2, wherein
the motor has
a top; and
a worm protruding out from the top of the motor;
the transmission assembly comprises
a holding bracket being mounted securely on the top of the motor, being mounted around the worm and having an inner cavity and two sides;
a central rod being mounted in the inner cavity of the holding bracket and having two ends being mounted respectively through the sides of the holding bracket;
a worm wheel being mounted securely around and driving the central rod, being mounted in the inner cavity of the holding bracket and meshing with and being driven by the worm on the motor;
two planet gears being respectively mounted securely around the ends of the central rod and being driven by the central rod; and
two driving rods being respectively mounted rotatably in the sides of the holding bracket;
each massaging assembly corresponds to one driving rod of the transmission assembly and has an internal gear meshing with and being driven by a corresponding planet gear, being mounted securely around the corresponding driving rod;
the moving gear assembly comprising
a drive gear being mounted securely around one driving rod;
a transfer shaft being mounted rotatably on the top surface of the carriage and being parallel to the driving rods;
a first driven gear being mounted securely around and rotating the transfer shaft and meshing with and being driven by the drive gear;
a transfer gear being mounted securely around and being rotated by the transfer shaft; and
a second driven gear being mounted securely around and rotating the driven shaft and meshing with and being driven by the transfer gear; and
the driven shaft of the moving gear assembly is parallel to the transfer shaft.

4. The body massager as claimed in claim 2, wherein
the carriage has two through holes being formed oppositely through the carriage and respectively corresponding to the gear racks of the base;
the moving gears respectively protrudes out of the through holes of the carriage; and
the outer cover has two slots being formed through the outer cover, aligning with the gear racks and being mounted respectively around the massaging bars to allow the massaging nodes to protrude through the slots.

5. The body massager as claimed in claim 3, wherein
each driving rod of the transmission assembly has
a proximal end;
a distal end;
a first rod pinhole being formed through the driving rod near the distal end of the driving rod; and
a second rod pinhole being formed through the driving rod near the proximal end of the driving rod;
the internal gear of each massaging assembly has
an outside surface;
a central shaft being formed on and protruding out from the outside surface of the internal gear;
a pinhole being formed transversely through the central shaft and aligning with the second rod pinhole of the corresponding driving rod; and
a pin being mounted securely through the pinhole of the central shaft and the second rod pinhole of the corresponding driving rod;
the first cam of each massaging assembly has
a mounting tube being formed on and protruding longitudinally out from the inclined surface of the first cam and being mounted securely around the corresponding driving rod; and
a cam pinhole being formed through the mounting tube and aligning with the first rod pinhole of the corresponding driving rod; and
the second cam of each massaging assembly has
a mounting tube being formed on and protrudes longitudinally out from the inclined surface of the second cam and being mounted securely around the mounting tube of the first cam;
a cam pinhole being formed through the mounting tube of the second cam and aligning with the cam pinhole of the first cam; and
a pin being mounted securely through the cam pinholes of the first and second cams and the first rod pinhole of the corresponding driving rod.

6. The body massager as claimed in claim 4, wherein
each driving rod of the transmission assembly has
a proximal end;
a distal end;
a first rod pinhole being formed through the driving rod near the distal end of the driving rod; and
a second rod pinhole being formed through the driving rod near the proximal end of the driving rod;
the internal gear of each massaging assembly has
an outside surface;
a central shaft being formed on and protruding out from the outside surface of the internal gear;
a pinhole being formed transversely through the central shaft and aligning with the second rod pinhole of the corresponding driving rod; and
a pin being mounted securely through the pinhole of the central shaft and the second rod pinhole of the corresponding driving rod;
the first cam of each massaging assembly has
a mounting tube being formed on and protruding longitudinally out from the inclined surface of the first cam and being mounted securely around the corresponding driving rod; and
a cam pinhole being formed through the mounting tube and aligning with the first rod pinhole of the corresponding driving rod; and
the second cam of each massaging assembly has
a mounting tube being formed on and protrudes longitudinally out from the inclined surface of the second cam and being mounted securely around the mounting tube of the first cam;
a cam pinhole being formed through the mounting tube of the second cam and aligning with the cam pinhole of the first cam; and
a pin being mounted securely through the cam pinholes of the first and second cams and the first rod pinhole of the corresponding driving rod.

7. The body massager as claimed in claim 5, wherein
the driving rods are keyed;
the internal gear of each massaging assembly has a keyhole being formed longitudinally through the central shaft and engaging the corresponding driving rod; and
the drive gear has a keyhole being formed longitudinally through the drive gear and engaging the corresponding driving rod.

8. The body massager as claimed in claim 6, wherein
the driving rods are keyed;
the internal gear of each massaging assembly has a keyhole being formed longitudinally through the central shaft and engaging the corresponding driving rod; and
the drive gear has a keyhole being formed longitudinally through the drive gear and engaging the corresponding driving rod.

9. The body massager as claimed in claim 3 further comprising a bearing assembly having
multiple bearings being mounted respectively around the driving rods, the transfer shaft and the driven shaft and being mounted on the top surface of the carriage;
multiple bearing covers being mounted respectively on the bearings; and
a motor cover being mounted on the motor.

10. The body massager as claimed in claim 8 further comprising a bearing assembly having
multiple bearings being mounted respectively around the driving rods, the transfer shaft and the driven shaft and being mounted on the top surface of the carriage;
multiple bearing covers being mounted respectively on the bearings; and
a motor cover being mounted on the motor.

11. The body massager as claimed in claim 1 further comprising two reverse switches being mounted on the top surface of the carriage, being respectively near the ends of the carriage and being selectively pressed by carriage.

12. The body massager as claimed in claim 10 further comprising two reverse switches being mounted on the top surface of the carriage, being respectively near the ends of the carriage and being selectively pressed by carriage.

13. The massager as claimed in claim 11 further comprising a middle switch mounted on the top surface of the base and mounted between the reverse switches.

14. The massager as claimed in claim 12 further comprising a middle switch mounted on the top surface of the base and mounted between the reverse switches.
